(19) United States
(12) Patent Application Publication
(10) Pub. No.: US 2024/0305841 A1
(43) Pub. Date: Sep. 12, 2024

(54) DYNAMIC RESOLUTION SWITCHING FOR CAMERA

(71) Applicant: Hewlett-Packard Development Company, L.P., Spring, TX (US)

(72) Inventors: Alan Man Pan Tam, Spring, TX (US); Shih Huang Wu, Spring, TX (US); King Sui Kei, Spring, TX (US); Yiko Hsiao, Spring, TX (US); Ruei-Ting Miau, Spring, TX (US)

(73) Assignee: Hewlett-Packard Development Company, L.P., Spring, TX (US)

(21) Appl. No.: 18/179,959

(22) Filed: Mar. 7, 2023

(51) Int. Cl. H04N 21/2343; H04N 21/2662

(52) U.S. Cl. CPC H04N 21/234363; H04N 21/2662

(57) ABSTRACT

Video image resolution information of a video stream associated with an application is accessed, the application executed by a computing device. Connection performance information of a wireless connection between the computing device and a network is accessed. Based on the video image resolution information and the connection performance information, a video image resolution for the video stream is selected.

### BACKGROUND

Generally described, computing devices can be associated with external devices, such as external camera devices, that can be utilized to provide video image data. For example, camera devices can provide video and audio information that can be processed by different applications, including for video conferencing, telephony, content creation, and other functions.

### BRIEF DESCRIPTION OF THE DRAWINGS

FIGS. 1A and 1B schematically illustrate two example configurations of a computing system in accordance with certain implementations described herein.

FIG. 2 is a plot of an example USB 2.0 transmit-pair signal data spectrum and a USB 3.0 transmit-pair signal data spectrum in accordance with certain implementations described herein.

FIG. 3 is an example MCS table of MCS index values for the IEEE 802.11ax wireless networking standard in accordance with certain implementations described herein.

FIGS. 4A and 4B are flow diagrams of two example methods for dynamically switching a communication standard used by an imaging device in accordance with certain implementations described herein.

### DETAILED DESCRIPTION

The external devices may be configured with differences in hardware and software resources to provide the video and audio information of different quality, which is often reflective in the amount of data utilized to represent the video or audio signals. In many scenarios, the external devices may be configured to provide video or audio data in accordance with one or more standardized formats for capturing the data and for transmitting the data between the external device and a computing device. Better image quality for video applications (e.g., video conferencing) of a computing device can be provided by video cameras with higher interface standards (e.g., higher frame rates; higher resolutions). For example, the Universal Serial Bus (USB) 3.x standard has higher frame rates and higher resolutions than does the USB 2.x standard. Electrical noise from the video camera and proximity of the video camera with the wireless communication antenna of the computing device can result in unwanted interference with the wireless communications (e.g., radio-frequency or RF) between the computing device and a network.

Operation of an imaging device (e.g., video camera) at higher interface standards can increase the potential for electrical interference affecting the wireless (e.g., RF) communications between the computing device and the network. Certain implementations described herein provide a system and method for dynamically switching a backward-compatible imaging device (e.g., a video camera capable of using either a higher interface standard or a lower interface standard) from using the higher interface standard (e.g., USB 3.x standard) to using the lower interface standard (e.g., USB 2.x standard). For example, the imaging device can use the lower interface standard when the camera application is not compatible with the higher interface standard or when the wireless RF environment of the computing device is sensitive to noise potentially resulting from use of the higher interface standard by the imaging device. Determining the compatibility of the camera application can be performed by obtaining the information from the camera application and determining the sensitivity of the wireless RF environment can be performed by accessing the modulation and coding scheme (MCS) index from a monitor application of the computing device at intervals. Dynamically switching the interface standard used by the imaging device to the lower interface standard can provide a more RF-friendly environment for wireless communications of the computing device while easing the data transmit loading of video signals from the imaging device through the computing device.

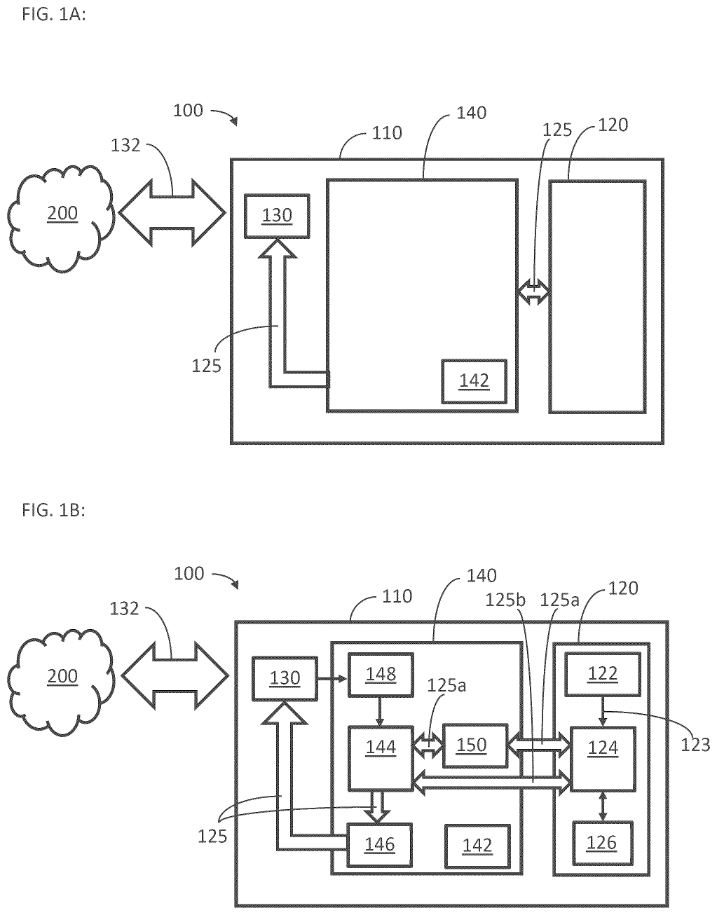

FIGS. 1A and 1B schematically illustrate two example configurations of a computing system 100 in accordance with certain implementations described herein. The computing system 100 comprises a computing device 110 in wireless communication (e.g., actively wirelessly exchanging packets of information or having an established wireless connection to actively wirelessly exchange packets of information) with a network 200. Examples of the computing device 110 include but are not limited to: personal computing devices; desktop computers; notebook computers; laptop computers; smartphones; smart tablets. Examples of the network 200 include, but are not limited to: the Internet, Ethernet networks, wide area networks (WAN), wireless local area networks (WLAN), wireless fidelity (WiFi) networks, wireless gigabit alliance (WiGig) networks, wireless personal area networks (WPAN), long-term evolution (LTE) standard networks, 5G networks. For example, the computing device 110 can comprise an antenna 130 that transmits and receives wireless signals 132 at WLAN frequencies (e.g., 2.4 GHz to 2.5 GHz; 5.1 GHz to 7.1 GHZ), examples of which include, but are not limited to, slot antennas; inverted-F antennas; WiFi antennas; WLAN antennas.

In certain implementations, the computing device 110 comprises a controller 140 (e.g., processor; microprocessor; application-specific integrated circuits; generalized integrated circuits programmed by computer executable instructions; microelectronic circuitry; microcontrollers) executes various applications. The controller 140 can comprise storage circuitry 142 or can be in operative communication with storage circuitry 142 separate from the controller 140. The storage circuitry 142 stores information (e.g., data; commands) accessed by the controller 140 during operation (e.g., while providing the functionality of certain implementations described herein). The storage circuitry 142 can comprise a tangible (e.g., non-transitory) computer readable storage medium, examples of which include but are not limited to: read only memory (ROM); random access memory (RAM); magnetic disk storage media; optical storage media; flash memory. The storage circuitry 142 can be encoded with software (e.g., a computer program downloaded as an application) comprising computer executable instructions for instructing the controller 140 (e.g., executable data access logic, evaluation logic, and/or information outputting logic). The controller 140 can execute the instructions of the software to provide functionality as described herein.

The computing system 100 further comprises the imaging device 120 (e.g., video camera) in operative communication with the controller 140. In certain implementations, as schematically illustrated by FIGS. 1A and 1B, the computing device 110 comprises the imaging device 120, while in certain other implementations, the imaging device 120 is separate from the computing device 110 and is in operative communication (e.g., wired or wireless communication) with the controller 140. As schematically illustrated by FIG. 1B, the imaging device 120 can comprise an image sensor 122, an image sensor processor 124, and an image data buffer 126. The image sensor 122 generates and transmits raw video signals 123 to the image sensor processor 124. The image sensor processor 124 performs operations on the raw video signals 123 (e.g., scaling; enhancing; removing artifacts) to produce processed video signals 125 that conform to a video interface standard and video image resolution of the imaging device 120. The image data buffer 126 can be used by the image sensor processor 124 to introduce a temporal delay (e.g., in a range of 100 milliseconds to 1 second) in the transmission (e.g., streaming) of the video signals 125 to the controller 140. In certain implementations, as schematically illustrated by FIG. 1B, the image sensor processor 124 is separate from the controller 140 of the computing device 110 and the image sensor processor 124 transmits the video signals 125 to the controller 140. In certain other implementations, the image sensor processor 124 is a component of the controller 140 and the image sensor processor 124 provides the video signals 125 to other components of the controller 140.

In certain implementations, the imaging device 120 is compatible with communications (e.g., first video stream) at a first video interface standard having a first video protocol (e.g., first image resolution) and compatible with communications (e.g., second video stream) at a second video interface standard having a second video protocol (e.g., second image resolution) different than the first video protocol. For example, the image sensor processor 124 can selectively generate and transmit first video signals 125a at the first video interface standard with the first video image resolution or second video signals 125b at the second video interface standard with the second video image resolution, the second video interface resolution less than the first video image resolution. The first video interface standard can be the Universal Serial Bus (USB) 3.x standard having a first video image resolution that is greater than or equal to a threshold value (e.g., the first video image resolution is greater than or equal to 8 megapixels (8MP)) and the second video interface standard can be the USB 2.x standard having a second video image resolution that is less than the threshold value (e.g., the second video image resolution is less than 8MP, such as 5MP). The second video image resolution can be sufficient for high definition (HD) video streaming (e.g., 720p having 1280×720 resolution; 1080p having 1920×1080 resolution), while the first video image resolution can be sufficient for 4K video streaming (e.g., 3840×2160 resolution; 4096×2160 resolution). The imaging device 120 can comprise a first output interface and a second output interface, the first output interface having a higher bandwidth than does the second output interface.

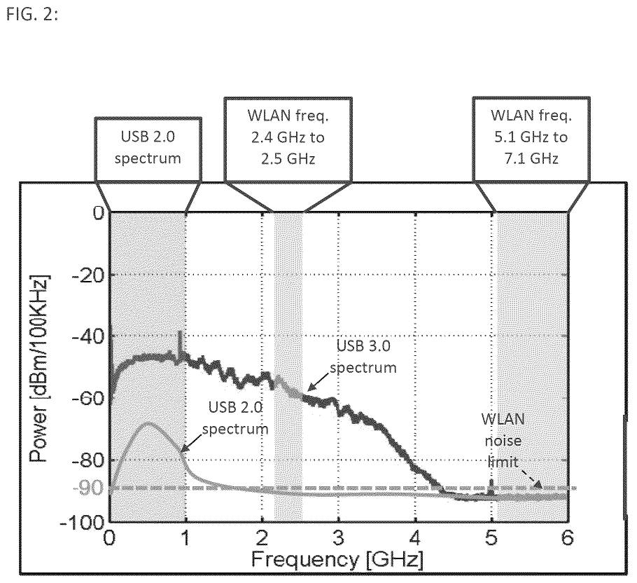

FIG. 2 is a plot of an example USB 2.0 transmit-pair signal data spectrum and a USB 3.0 transmit-pair signal data spectrum in accordance with certain implementations described herein. The USB 2.0 spectrum has an operating frequency at 480 MHz and harmonics at 240 MHz and 980 MHz. Over a range of frequencies of about 0 to 1 GHz, the power of the USB 2.0 spectrum is greater than a WLAN noise limit for wireless communications, but the power of the USB 2.0 spectrum is below the WLAN noise limit in the WLAN frequency bands for wireless communications (e.g., 2.4 GHz to 2.5 GHz; 5.1 GHz to 7.1 GHZ). In contrast, the power of the USB 3.0 spectrum is greater than that of the USB 2.0 spectrum and greater than the WLAN noise limit across a frequency range of 0 to about 4.4 GHz, including the WLAN frequency band (e.g., 2.4 GHz to 2.5 GHZ). As a result, operation of an imaging device 120 using the USB 3.0 interface standard has a higher probability to generate RF interference on the WLAN wireless communications via the antenna 130 than does operation of the imaging device 120 using the USB 2.0 interface standard.

In certain implementations, the computing device 110 provides the video signals 125 to another device, separate from the computing device 110, by transmitting the video signals 125 to the network 200 as wireless signals 132 via the antenna 130. For example, as schematically illustrated by FIG. 1B, the controller 140 can be running an application programming interface (API) 144 and a camera application 146, the API 144 receiving the video signals 125 from the imaging device 120 (e.g., from the image sensor processor 124) and providing the video signals 125 to the camera application 146, and the camera application 146 operating on and providing the video signals 125 to the antenna 130. The camera application 146 can also receive video signals from another device, separate from the computing device 110, via the network 200 and the antenna 130 and to operate on and provide these received video signals to other components of the controller 140 or other applications (e.g., programs) being run by the controller 140. Examples of camera applications 146 compatible with certain implementations described herein include, but are not limited to, video conferencing applications, video security monitoring applications, and video editing applications.

The camera application 146 can be compatible with (e.g., capable of operating on or being used with) video signals at the first video interface standard having the first video image resolution or compatible with video signals at the second video interface standard having the second video image resolution (e.g., the camera application 146 can use the first video image resolution; the camera application can use the second video image resolution). The camera application 146 can provide video image information (e.g., to the API 144) indicative of the video interface standard, the video image resolution, or both the video interface standard and the video image resolution with which the camera application 146 is compatible.

For example, the video image information can indicate that the camera application 146 is compatible with either video signals at the USB 3.x standard having the first video image resolution sufficient for 4K video streaming (e.g., greater than or equal to 8MP) or video signals at the USB 2.x standard having the second video image resolution sufficient for HD video streaming (e.g., less than 8MP). For another example, the video image information can indicate that the camera application 146 is compatible with only video signals at the USB 3.x standard having the first video image resolution (e.g., the camera application 146 only uses the first video image resolution). For still another example, the video image information can indicate that the camera application 146 is compatible only with video signals at the USB 2.x standard having the second video image resolution (e.g., the camera application 146 only uses the second video image resolution).

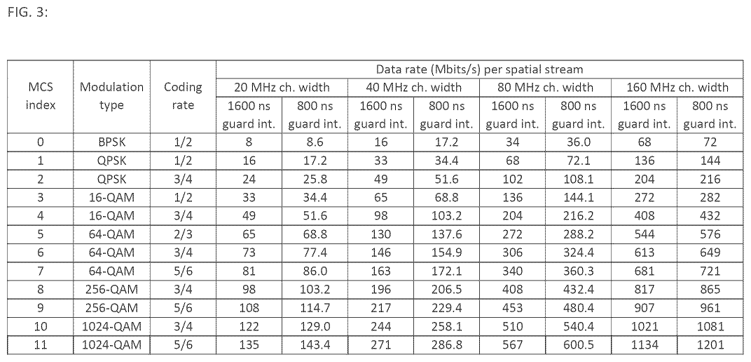

In certain implementations, the computing device 110 monitors (e.g., in real-time) a wireless network performance between the computing device 110 and the network 200. As schematically illustrated by FIG. 1B, the controller 140 can be running a monitor application 148 (e.g., a built-in application of the operating system executed by the controller 140) that accesses (e.g., receives) connection performance information indicative of the wireless connection (e.g., network performance) from the antenna 130. In certain implementations, the connection performance information received by the monitor application 148 comprises a modulation coding scheme (MCS) index which is a metric indicative of the wireless network performance based on multiple communication parameters. In certain other implementations, the connection performance information received by the monitor application 148 comprises a plurality of communication parameters, and the monitor application 148 determines the corresponding MCS index using the received plurality of communication parameters. Examples of the communication parameters, include but are not limited to: type of phase and amplitude modulation for bit encoding (e.g., binary phase shift keying or BPSK, quadrature phase shift keying or QPSK, quadrature amplitude modulation or QAM, e.g., 16-QAM, 64-QAM, 256-QAM, 1024-QAM); coding rate (e.g., including information regarding the number of bits used for transferring information and the number of bits used for error correction; can be expressed as a fraction of the number of information-transferring bits divided by the sum of information-transferring bits and error-correction bits); number of spatial streams (e.g., independent data streams); data rate per spatial stream; channel width (e.g., bandwidth of channel used for communications); guard interval (e.g., time between transmitted packets). For example, the monitor application 148 can access an MCS table (e.g., from storage circuitry 142) listing the MCS index corresponding to various communication parameters and can look up the real-time MCS index corresponding to the received connection performance information. FIG. 3 is an example MCS table of MCS index values for the IEEE 802.11ax wireless networking standard in accordance with certain implementations described herein.

In certain implementations, the computing device 110 (e.g., the controller 140) comprises a switch 150 that selects (e.g., dynamically) a video interface standard, a video image resolution, or both a video interface standard and a video image resolution for communications by the imaging device 120 to the camera application 146. For example, as schematically illustrated by FIG. 1B, the ISP 124 of the imaging device 120 can transmit the video signals 125 to the controller 140 as both first video signals 125a with the first video interface standard (e.g., USB 3.x) having the first video image resolution and second video signals 125b with the second video interface standard (e.g., USB 2.x) having the second video image resolution. The switch 150 is in the transmission path of the first video signals 125a but is not in the transmission path of the second video signals 125b. The controller 140 can activate the switch 150 to select (e.g., dynamically) one of the first output interface and the second output interface based on the video image resolution information and the connection performance information.

In the example configuration schematically illustrated by FIG. 1B, the API 144 defaults to using the video signals 125 that the API 144 receives having the highest video interface standard (e.g., the highest video image resolution). For example, if the API 144 received both the first video signals 125a and the second video signals 125b, the API 144 provides the first video signals 125a to the camera application 146, if the API 144 only receives the first video signals 125a, the API 144 provides the first video signals 125a to the camera application 146, and if the API 144 only receives the second video signals 125b, the API 144 provides the second video signals 125b to the camera application 146.

In certain implementations, the API 144 receives both the video image information (e.g., from the camera application 146) and the connection performance information (e.g., from the monitor application 148) and comprises an embedded controller (EC) that generates control signals in response to the video image information and the connection performance information and to transmit the control signals via a general purpose input/output (GPIO) to the switch 150. For example, if the video image information indicates that the camera application 146 can only use video signals 125 having less than the first video image resolution (e.g., unable to use the first video signals 125a), the EC generates control signals that the switch 150 responds to by blocking the first video signals 125a from being received by the API 144, such that only the second video signals 125b are received by the API 144. For another example, if the connection performance information indicates that the wireless communications between the computing device 110 and the network 200 are substantially sensitive to electrical interference, the EC generates control signals that the switch 150 responds to by blocking the first video signals 125a from being received by the API 144, such that only the second video signals 125b are received by the API 144. For another example, if the video image information indicates that the camera application 146 can use video signals 125 having the first video image resolution (e.g., able to use the first video signals 125a) and the connection performance information indicates that the wireless communications between the computing device 110 and the network 200 are not substantially sensitive to electrical interference, the EC generates control signals that the switch 150 responds to be allowing the first video signals 125a to be received by the API 144.

In certain implementations, to determine whether the wireless communications between the computing device 110 and the network are substantially sensitive to electrical (e.g., RF) interference or not, the controller 140 compares the wireless network performance to a wireless network performance threshold (e.g., the wireless communications substantially sensitive if the wireless network performance is less than the threshold and not substantially sensitive if the wireless network performance is greater than or equal to the threshold). For connection performance information comprising an MCS index, a MCS threshold can be used that corresponds to a sufficient wireless network performance (e.g., a good WiFi experience). For example, for a 64-QAM modulation type, an MCS threshold of 5 can be used, such that if the MCS index received by the API 144 is less than 5, the wireless network performance is considered to be substantially sensitive to electrical interference, and if the MCS index received by the API 144 is greater than or equal to 5, the wireless network performance is considered to be not substantially sensitive to electrical interference.

As schematically illustrated in FIG. 1B, the switch 150 is a component of the controller 140 and, in response to the control signals, the switch 150 either blocks the first video signals 125a from being received by the API 144 and from being provided by the API 144 to the camera application 146 or allows the first video signals 125a to be received by the API 144 and provided by the API 144 to the camera application 146. Other configurations of the switch 150 are also compatible with certain implementations described herein. For example, the switch 150 can be a component of the ISP 124 or a component of the API 144. For another example, the switch 150 can be in the transmission path of both the first video signals 125a and the second video signals 125b, and can selectively block one of the first video signals 125a and the second video signals 125b from being received by the API 144 and can selectively allow the other of the first video signals 125a and the second video signals 125b to be received by the API 144.

In certain implementations, the controller 140 periodically accesses the connection performance information at temporal intervals (e.g., to repeatedly evaluate in real-time whether the first video signals 125a or the second video signals 125b are to be provided to the camera application 146). For example, the API 144 can obtain (e.g., request) the connection performance information from the antenna 130 at temporal intervals in a range of 30 seconds to 2 minutes. Upon the switch 150 being used to change the video signals 125 being provided to the camera application 146, the ISP 124 can utilize the image data buffer 126 to delay the video signals 125 streaming to the controller 140 to prevent (e.g., avoid) interruptions in the streaming video signals 125 (e.g., temporarily frozen images or blacked-out images) due delays introduced by the switching between the first video signals 125a and the second video signals 125b by the switch 150.

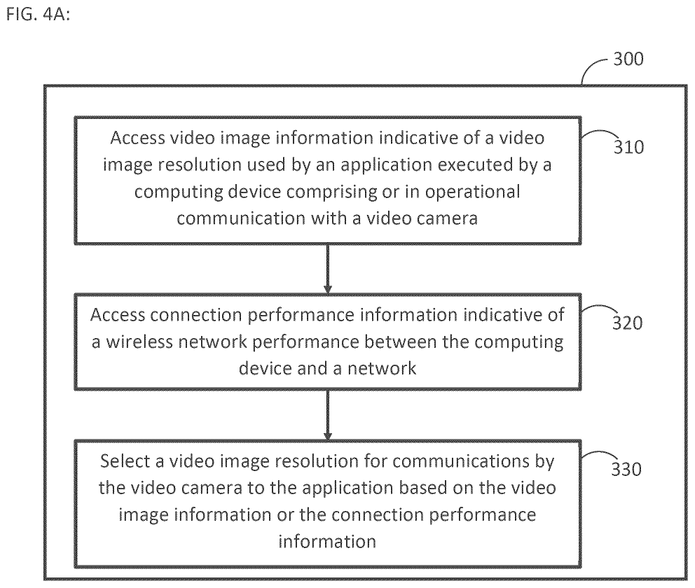

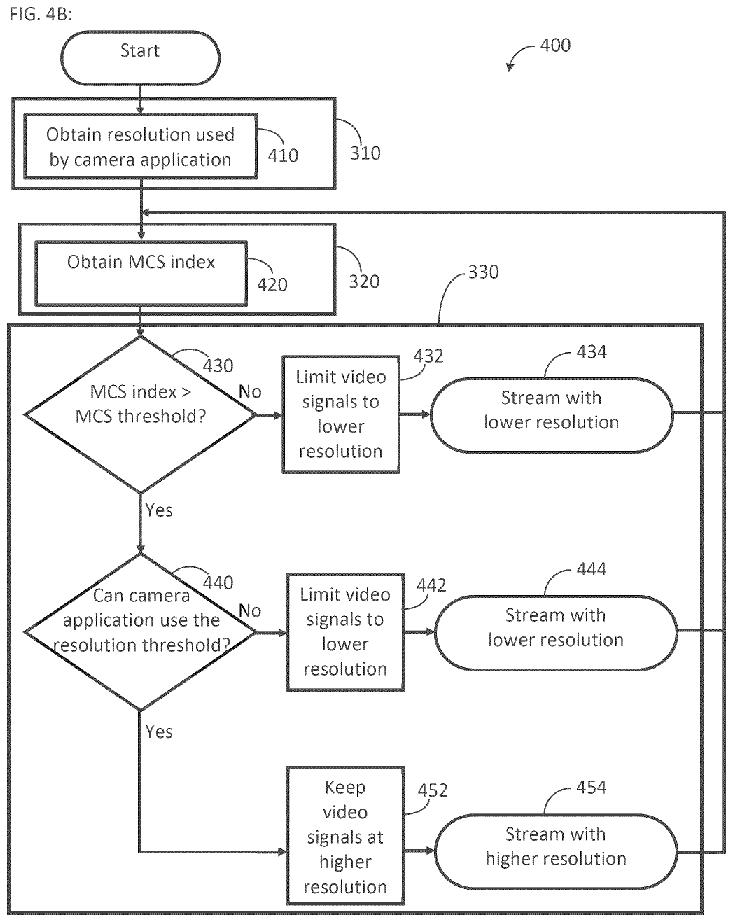

FIGS. 4A and 4B are flow diagrams of two example methods 300, 400 for dynamically switching a communication standard used by an imaging device in accordance with certain implementations described herein. The method 400 is an example of the method 300. The storage circuitry 142 (e.g., non-transitory, computer-readable medium) of the computing device 110 can have stored thereon a set of instructions that, when executed by the computing device 110 (e.g., by the controller 140), cause the computing device 110 to perform the method 300, 400 (e.g., as part of a background service operation of the computing device 110). The computing device 110 comprises or is in operational communication with the imaging device 120 compatible with communications having a first video image resolution and compatible with communications having a second video image resolution. The computing device 110 is executing an application (e.g., camera application 146)

In an operational block 310, the method 300 comprises accessing (e.g., receiving) video image information associated with the application (e.g., camera application 146) executed by the computing device 110. As shown in FIG. 4B, the API 144 can obtain (e.g., request) the video image resolution information from the camera application 146 in an operational block 410.

In an operational block 320, the method 300 further comprises accessing (e.g., receiving) connection performance information of a wireless connection between the computing device 110 and a network 200. As shown in FIG. 4B, the API 144 can obtain (e.g., request) the connection performance information (e.g., real-time MCS index) from the monitor application 148 in an operational block 420.

In an operational block 330, the method 300 further comprises, selecting a video image resolution for a video stream provided to the application, said selecting based on the video image resolution information and the connection performance information. For example, the second video image resolution can be selected for communications by the imaging device 120 to the application in response to either the video image resolution information indicating a usage by the application of a video image resolution less than the first video image resolution or the connection performance information indicating that the wireless network performance is less than a wireless network performance threshold. As shown in FIG. 4B, the connection performance information can comprise an MCS index (e.g., indicative of the RF interference sensitivity of the wireless communications between the computing device 110 and the network 200) and can be compared to a MCS threshold in an operational block 430. If the MCS index is less than or equal to the MCS threshold, in an operational block 432, the ISP 124 is limited to providing the video signals 125b having the second video image resolution (e.g., USB 2.x) to the API 144 and in an operational block 434, the video signals 125b are streamed to the camera application 146.

If the comparison of the operational block 430 finds that MCS index is greater than the MCS threshold, then in an operational block 440, the video image resolution used by the camera application 146 (e.g., video image resolution information) is compared to video image resolutions with which the imaging device 120 is compatible. For example, if the camera application 146 is unable to use a resolution threshold (e.g., 8MP video resolution; the first video image resolution; the video image resolution of USB 3.x), in an operational block 442, the ISP 124 is limited to providing the video signals 125b having the second video image resolution (e.g., USB 2.x) to the API 144 and in an operational block 444, the video signals 125b are streamed to the camera application 146. If the comparison of the operational block 440 finds that the camera application 146 is able to use a resolution threshold, in an operational block 452, the ISP 124 can provide the video signals 125a having the first video image resolution (e.g., USB 3.x) to the API 144 and in an operational block 454, the video signals 125a are streamed to the camera application 146. In certain implementations, the resolution threshold can be set to be the largest data limit that the USB 2.x standard can easily support with good signal integrity (e.g., quality). For example, if the camera application 146 supports 8MP, then the USB 3.x standard can be used and the resolution threshold can be 8MP.

After the operational blocks 434, 444, 454, the method 400 can comprise repeating the operational blocks 320, 420 to obtain a real-time update of the connection performance information and reevaluating whether to provide the first video signals 125a or the second video signals 125b to the API 144. For example, the API 144 can obtain (e.g., request) the connection performance information from the antenna 130 at temporal intervals in a range of 30 seconds to 2 minutes.

Without the systems and methods described herein, a camera application 146 compatible only with HD video streaming but receiving 4K video signals from the imaging device 120 would have the burden of framing the received 4K video signals for HD video streaming to the network 200. In contrast, the dynamical switching of the imaging device 120 from USB 3.x to USB 2.x in certain implementations described herein can provide the camera application 146 with video signals (e.g., with 5MP data) compatible with HD video streaming. In addition, such dynamical switching to provide HD video signals can reduce the risk of RF interference, e.g., when the wireless communications between the computing device 110 and the network 200 are more vulnerable to RF noise. Certain implementations described herein can improve throughput by reducing (e.g., minimizing) the noise impact on antenna performance. Certain implementations described herein can save system fabrication costs by avoiding mechanical solutions previously used to shield the antenna 130 from RF interference from the imaging device 120. Certain implementations described herein can improve space usage efficiency by reducing the physical spacing between the antenna 130 and the imaging device 120 as compared to the spacing used with higher RF interference risks. Certain implementations described herein can improve battery life and skin temperature of the computing device 110 by reducing the system power consumption (e.g., the USB 3.0 standard has a power delivery increase of 4.5 W, which is higher than that of the USB 2.0 standard of 2.5 W).

Although commonly used terms are used to describe the systems and methods of certain implementations for ease of understanding, these terms are used herein to have their broadest reasonable interpretations. Although various aspects of the disclosure are described with regard to illustrative examples and implementations, the disclosed examples and implementations should not be construed as limiting. Conditional language, such as, among others, “can,” “could,” “might,” or “may,” unless specifically stated otherwise, or otherwise understood within the context as used, is generally intended to convey that certain implementations include, while other implementations do not include, certain features, elements and/or steps. Thus, such conditional language is not generally intended to imply that features, elements and/or steps are in any way required for one or more implementations or that one or more implementations necessarily include logic for deciding, with or without user input or prompting, whether these features, elements and/or steps are included or are to be performed in any particular implementation. In particular, the terms “comprises” and “comprising” should be interpreted as referring to elements, components, or steps in a non-exclusive manner, indicating that the referenced elements, components, or steps may be present, or utilized, or combined with other elements, components, or steps that are not expressly referenced.

It is to be appreciated that the implementations disclosed herein are not mutually exclusive and may be combined with one another in various arrangements. In addition, although the disclosed methods and apparatuses have largely been described in the context of plasma compression systems, various implementations described herein can be incorporated in a variety of other suitable devices, methods, and contexts.

Language of degree, as used herein, such as the terms “approximately,” “about,” “generally,” and “substantially,” represent a value, amount, or characteristic close to the stated value, amount, or characteristic that still performs a desired function or achieves a desired result. For example, the terms “approximately,” “about,” “generally,” and “substantially” may refer to an amount that is within +10% of, within +5% of, within +2% of, within +1% of, or within +0.1% of the stated amount. As another example, the terms “generally parallel” and “substantially parallel” refer to a value, amount, or characteristic that departs from exactly parallel by +10 degrees, by +5 degrees, by +2 degrees, by #1 degree, or by +0.1 degree, and the terms “generally perpendicular” and “substantially perpendicular” refer to a value, amount, or characteristic that departs from exactly perpendicular by +10 degrees, by +5 degrees, by +2 degrees, by +1 degree, or by +0.1 degree. The ranges disclosed herein also encompass any and all overlap, sub-ranges, and combinations thereof. Language such as “up to,” “at least,” “greater than,” less than,” “between,” and the like includes the number recited. As used herein, the meaning of “a,” “an,” and “said” includes plural reference unless the context clearly dictates otherwise. Also, as used in the description herein, the meaning of “in” includes “into” and “on,” unless the context clearly dictates otherwise.

While the methods and systems are discussed herein in terms of elements labeled by ordinal adjectives (e.g., first, second, etc.), the ordinal adjective are used merely as labels to distinguish one element from another (e.g., one signal from another or one circuit from one another), and the ordinal adjective is not used to denote an order of these elements or of their use.

What is claimed is:

1. A non-transitory, computer-readable medium having stored thereon a set of instructions that, when executed by a computing device having a memory and a processor, cause the computing device to:
in response to executing an application at the computing device:
access video image resolution information associated with the application;
access connection performance information of a wireless connection between the computing device and a network; and
select a video image resolution for a video stream to be provided to the application, said selecting based on the video image resolution information and the connection performance information.

2. The non-transitory, computer-readable medium of claim 1, wherein the video stream is received from a video camera compatible with communications having a first video image resolution and compatible with communications having a second video image resolution, the second video image resolution less than the first video image resolution.

3. The non-transitory, computer-readable medium of claim 2, wherein communications of the video camera at the first video image resolution are via a first video interface standard and communications of the video camera at the second video image resolution are via a second video interface standard, said selecting comprising selecting the second video interface standard for communications of the video camera with the application.

4. The non-transitory, computer-readable medium of claim 3, wherein said accessing the connection performance information comprises requesting a modulation and coding scheme (MCS) index from a monitor application of the computing device.

5. The non-transitory, computer-readable medium of claim 4, wherein said selecting comprises:
comparing the MCS index to a MCS threshold;
in response to the MCS index being less than the MCS threshold, selecting the second video interface standard for the communications by the video camera;
in response to the MCS index being greater than the MCS threshold, comparing the video image resolution used by the application to the first and second video image resolutions;
in response to said comparing indicating that the video image resolution used by the application is compatible with the first video image resolution, selecting the first video interface standard for the communications by the video camera; and
in response to said comparing indicating that the video image resolution used by the application is compatible with the second video image resolution, selecting the second video interface standard for the communications by the video camera.

6. The non-transitory, computer-readable medium of claim 3, wherein the first video interface standard is a Universal Serial Bus (USB) 3.x standard and the second video interface standard is a USB 2.x standard.

7. The non-transitory, computer-readable medium of claim 1, wherein the application is in communication with an application programming interface (API) of the computing device.

8. The non-transitory, computer-readable medium of claim 7, wherein said accessing the video image resolution information comprises requesting, by the API, the video image resolution information from the application.

9. The non-transitory, computer-readable medium of claim 7, wherein the non-transitory, computer-readable medium causes the computing device to, in response to said selecting, switch communications between an image sensor processor of a video camera providing the video stream and the API of the computing device to be compatible with said selected video image resolution.

10. A computing device comprising:
an imaging device having a first output interface and a second output interface, wherein the first output interface has a higher bandwidth than does the second output interface; and
a controller to:
access video image resolution information associated with an application;
access connection performance information of a wireless connection between the computing device and a network; and
select one of the first output interface and the second output interface based on the video image resolution information and the connection performance information.

11. The computing device of claim 10, wherein the first output interface bandwidth is compatible with a video image resolution greater than or equal to a threshold value and the second output interface bandwidth is compatible with a video image resolution less than the threshold value.

12. The computing device of claim 10, further comprising a switch that dynamically switches between the first output interface and the second output interface based on the video image resolution information and the connection performance information.

13. The computing device of claim 12, wherein the controller comprises the switch.

14. The computing device of claim 12, wherein the imaging device is compatible with communications at the first output interface bandwidth and compatible with communications at the second output interface bandwidth, wherein the imaging device comprises an image sensor and an image sensor processor (ISP), the image sensor generating and transmitting video signals to the ISP, the ISP providing the video signals to the controller as first video signals having the first output interface bandwidth and second video signals having the second output interface bandwidth.

15. The computing device of claim 14, wherein the ISP comprises the switch.

16. The computing device of claim 14, wherein the imaging device further comprises an image data buffer that is used by the ISP to introduce a temporal delay in transmission of the video signals to the controller.

17. The computing device of claim 14, wherein the switch either blocks the first video signals from being received by an application programming interface (API) of the controller or allows the first video signals to be received by the API.

18. A non-transitory, computer-readable medium having stored thereon a set of instructions that, when executed by a computing device having a memory and a processor, cause the computing device to, in response to executing an application at the computing device:
receive first and second video streams from an imaging device, the first video stream having a first video protocol and the second video stream having a second video protocol, the second video protocol different than the first video protocol; and
provide either only the second video stream or both the first and second video streams to the application in response to video protocol compatibility of the application or in response to a network performance, monitored in real-time, between the computing device and a network.

19. The non-transitory, computer-readable medium of claim 18, wherein the network performance has a first probability of interference from the first video stream and a second probability of interference from the second video stream, the second probability less than the first probability, said providing only the second video stream in response to the first and second probabilities.

20. The non-transitory, computer-readable medium of claim 18, wherein the non-transitory, computer-readable medium causes the computing device to repeatedly receive, at a frequency, information indicative of the network performance.
